(19) United States
(12) Patent Application Publication
(10) Pub. No.: US 2002/0118090 A1
(43) Pub. Date: Aug. 29, 2002

(54) Shape memory alloy actuators activated by strain gradient variation during phase transformation

(76) Inventors: Byong-Ho Park, San Francisco, CA (US); Friedrich B. Prinz, Woodside, CA (US)

Correspondence Address: MAREK ALBOSZTA, LUMEN INTELLECTUAL PROPERTY SERVICES, SUITE 110, 45 CABOT AVENUE, SANTA CLARA, CA, 95051, US

(21) Appl. No.: 10/029,402

(22) Filed: Dec. 19, 2001

Related U.S. Application Data
(60) Provisional application No. 60/260,169, filed on Jan. 5, 2001.
(60) Provisional application No. 60/257,214, filed on Dec. 20, 2000.

(51) Int. Cl. H01H 37/46; H01H 37/50

(52) U.S. Cl. 337/139; 337/140; 148/402; 310/306

(57) ABSTRACT

The present invention provides actuators and actuator devices that take advantage of a strain gradient variation of an actuator element between a first phase and a second phase. The actuator elements can be positioned in any type of shape. For instance, the actuator element in the first phase can be any type of curved, non-linear or irregular shape as long as a strain gradient along a cross-section of the actuator element can be established. The actuator element in the second phase is positioned in a different shape when compared to the first phase as long as it is in a direction to minimize the strain gradient. Different actions can be generated such as a rotary movement, a linear movement, an expanding movement, or a combined linear and rotary movement. The actuator element could also be configured to generate a linear movement by combining contraction and strain gradient variation.

### CROSS-REFERENCE TO RELATED APPLICATIONS

This application is cross-referenced to and claims priority from U.S. Provisional Applications 60/260,169 filed Jan. 5, 2001 and 60/257,214 filed Dec. 20, 2000, which are both hereby incorporated by reference.

### STATEMENT REGARDING FEDERALLY SPONSORED RESEARCH OR DEVELOPMENT

This invention was supported in part by grant number F49620-99-1-0129 from the Air Force Office of Science Research. The U.S. government has certain rights in the invention.

### FIELD OF THE INVENTION

This invention relates generally to shape memory alloys. More particularly, the present invention relates to shape memory alloy actuators that are activated by strain gradient variation during phase transformation.

### BACKGROUND

Shape memory alloy (SMA) actuators have advantages of, for instance, high power density (>1000 W/kg), large stress (>200 MPa) and large strain (˜4%) when compared to other actuators such as piezoelectric and electrostatic actuators. Due to the advantages of SMA actuators, the prior art teaches various kinds of actuator systems that can have motions with strong force. The general type of SMA actuators is a wire due to its robust performance, long cycle life and low fabrication complexity. In general, these prior art teachings of SMA actuators are based on the shortening or contraction of SMA wires, because SMA wires have maximum force in the direction of contraction (see, for instance, U.S. Pat. Nos. 4,761,955, 4,979,672, 5,396,769, 5,127,228, 5,808,837, 5,825,275 and 6,242,841. The prior art teaches SMA wires to be arranged in the SMA actuators to maximize performance in the direction of contraction. Following this approach, SMA actuators can achieve a maximum force of about 600 MPa out of SMA wires. However, the main disadvantage of this approach is the dependency of the wire displacement on actuator sizes. For instance, if the SMA actuators are required to have certain angular deflection, the requirement cannot be satisfied without keeping the length of SMA wires identical while the actuators are scaled down due to fixed contraction strains (4˜5%). This argues against the miniaturization of conventional SMA actuator systems. Furthermore, some prior art teaches SMA rotary actuator devices. These rotary device are built by winding SMA wires around a rotating shaft and using the contraction or shortening of the SMA wires as the main actuator mechanism. As mentioned above, this approach has crucial disadvantages in scaling down actuator sizes since it requires the long length of wires to achieve large enough angular deflection due to the fixed contraction strains (4˜5%). In addition, wire-winding itself adds complexity and affects robustness of the actuators. Accordingly, there is a need to develop new approaches that allow for miniaturization of SMA actuators.

### SUMMARY OF THE INVENTION

The present invention provides actuators that take advantage of the strain gradient variation of an actuator element. In particular, the present invention provides actuators that take advantage of the strain gradient variation between a first phase and a second phase. In a preferred embodiment, the actuator element includes a shape memory alloy and the first state is a Martensite phase of the shape memory alloy and the second phase is an Austenite phase of the shape memory alloy.

The actuator elements of the present invention can be positioned in any type of shape. For instance, the actuator element in the first phase can be any type of curved, non-linear or irregular shape as long as a strain gradient along a cross-section of the actuator element can be established. The actuator element in the second phase is positioned in a different shape when compared to the shape in the first phase as long as it is in a direction to minimize the strain gradient.

The actuator of the present invention can be configured to generate different actions or movements when transitioning and taking advantage of the strain gradient variation from the first phase to the second phase. Examples of such movements are, for instance, but not limited to, a rotary movement, a linear movement, an expanding movement, or a combined linear and rotary movement. The actuator of the present invention could also be configured to generate a linear movement by combining contraction and strain gradient variation.

The present invention also provides a method of making an actuator. The method includes the step of providing an actuator element to which a strain gradient is established between a first phase and a second phase of the actuator element. Furthermore, the method includes an activating means to activate the actuator element and transition the actuator element from the first phase to the second phase.

The actuator of the present invention is also provided as an actuator device wherein the actuator is included as part of a device such as, but not limited to, a medical device, a robotic device, a joint mechanism, a switch, a relay or the like. The actuator is either integrated or embedded in the actuator device. The actuator device includes a first body. An actuator element with a first end is attached to the first body. In one embodiment, the actuator device of the present invention could further include a second body that is attached to a second end of the actuator element. The first body is then movably attached to the second body by a connecting means, such as, but not limited to, a joint. In an alternative embodiment, the actuator device of the present invention further includes a second body wherein the second body is attached to a point in between the first end and the second end of the actuator element. The second end is now attached to the first body.

The present invention also provides a method of making an actuator device. The method includes the step of providing a first body. The method further includes the step of providing an actuator element with a first end attached to the first body. Furthermore, the method includes an activating means to activate the actuator element and transition the actuator element from the first phase to the second phase. In one embodiment, the method further includes the step of providing a second body attached to a second end of the actuator element. The first body is movably attached to the second body by a connecting means, such as, but not limited to, a joint. In an alternative embodiment, the method could further include a second body wherein the second body is attached to a point in between the first end and a second end of the actuator element. The second end is attached to the first body. Furthermore, the method includes the step of embedding the actuator element in the actuator device.

In view of that which is stated above, it is the objective of the present invention to provide an actuator with an actuator element that activates by a strain gradient variation between a first phase and a second phase.

It is another objective of the present invention to provide actuators with different configurations.

It is yet another objective of the present invention to provide an actuator that undergoes a transition from the first phase to the second phase in a direction to minimize the strain gradient.

It is still another objective of the present invention to provide an actuator to generate a rotary movement when transitioning from the first phase to the second phase.

It is still another objective of the present invention to provide an actuator to generate a linear movement when transitioning from the first phase to the second phase.

It is still another objective of the present invention to provide an actuator to generate combined linear and rotary movement when transitioning from said the phase to the second phase.

It is still another objective of the present invention to provide an actuator to generate a linear movement by combining contraction and strain gradient variation.

It is still another objective of the present invention to miniaturize actuators to meso or micro-scale.

It is still another objective of the present invention to provide an actuator device and locally place the actuator in the actuator device.

It is still another objective of the present invention to provide an actuator device and embed the actuator in the actuator device.

The advantage of the present invention over the prior art is that the system enables one to develop actuators and actuator devices that can achieve large deflections or movements without the need of long wires. Another advantage of the present invention is that the actuators and actuator devices can be scaled and miniaturized to meso or micro-scale, which is difficult and hard to accomplish using contraction of the actuator element. Yet another advantage of the present invention is that the actuators and actuator devices become simple and robust by having SMAs locally placed or embedded in the actuator parts or device. Furthermore, as the actuator sizes decreases, it has more advantages in terms of cooling effects of SMA wires, which is directly related to the bandwidth of actuator systems.

### BRIEF DESCRIPTION OF THE FIGURES

The objectives and advantages of the present invention will be understood by reading the following detailed description in conjunction with the drawings, in which:

FIG. 1 shows a strain gradient of an actuator according to the present invention;

FIG. 2 shows an example of a strain distribution of an actuator according to the present invention;

FIG. 3 shows an example of an actuator movement according to the present invention;

FIG. 4 shows an exemplary embodiment of a configuration of an actuator that provides a push motion according to the present invention;

FIG. 5 shows an exemplary embodiment of a configuration of an actuator that provides a pull and expanding motion according to the present invention; and

FIGS. 6-7 shows exemplary embodiments of an actuator device according to the present invention.

### DETAILED DESCRIPTION OF THE INVENTION

Although the following detailed description contains many specifics for the purposes of illustration, anyone of ordinary skill in the art will readily appreciate that many variations and alterations to the following exemplary details are within the scope of the invention. Accordingly, the following preferred embodiment of the invention is set forth without any loss of generality to, and without imposing limitations upon, the claimed invention.

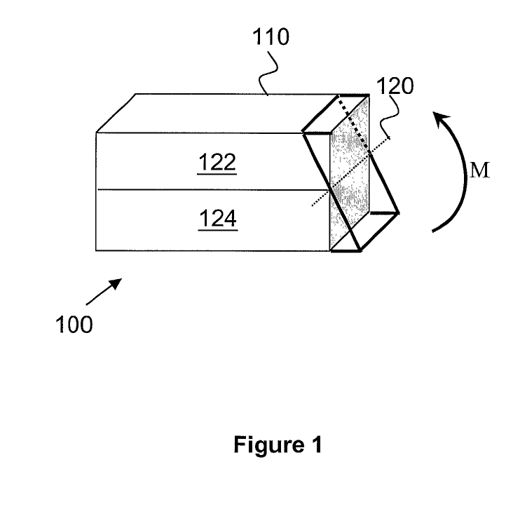

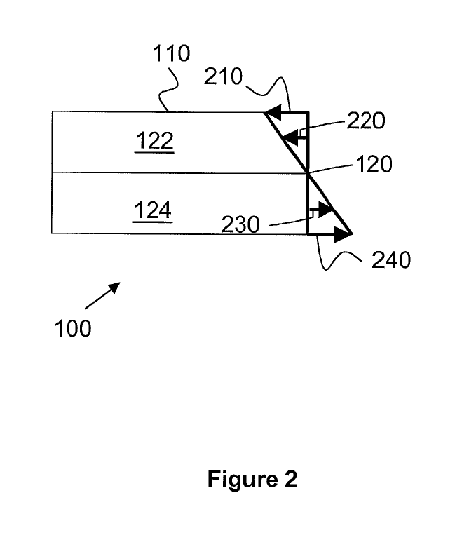

The present invention provides an actuator 100 with an actuator element 110 that is based on a strain gradient as shown in FIG. 1. The strain gradient varies between a first phase and a second phase. In the first phase, actuator element 110 has a higher strain gradient than in the second phase. In other words, the strain gradient minimizes when the actuator element transitions from the first phase to the second phase. In the example of FIG. 1, the strain gradient is defined relative to a neutral axis 120 of actuator element 110 along a cross-section of the actuator element. A torque M is applied that develops the strain gradient to actuator element 110 bringing one part of actuator element 110 under compression 122 and another part of actuator element 110 under tension 124. FIG. 2 shows the different strain distributions 210, 220 (both compression) and 230, 240 (both tension) of actuator element 110. Actuator element 110 is preferably a shape memory alloy (SMA), but could be any type of actuator that can retain a strain gradient variation. Different SMA materials could be used, such as, nitinol or any superelastic material. An SMA is preferably and conveniently a wire, but could take any other form suitable for its application.

An activating means (not shown) activates actuator element 110 and generates the transition from the first phase to the second phase. SMA is subject to a temperature change. In that case, the actuator means includes a heating means to activate the SMA and provide the transition from the first phase to the second phase. The first phase in an SMA is called Martensite phase (low temperature, e.g. room temperature) and the second phase in an SMA is called Austenite phase (high temperature). At a low temperature an SMA wire has a low stiffness because it is in its Martensite phase and exhibits a Young's Modulus of about 28 MPa. At a high temperature the SMA wire has a high stiffness due to its transition to the Austenite phase. In this phase the SMA wire has a Young's Modulus of about 75 MPa. In addition to the pure modulus change, there is another contribution of the strain gradient, which is a shortening and widening of SMA wires during contraction. In accordance with the present invention, these strain gradient changes make it possible to provide an actuator, such as a rotary actuator, which uses a comparatively short length of wire to obtain a large angular movement or deflection.

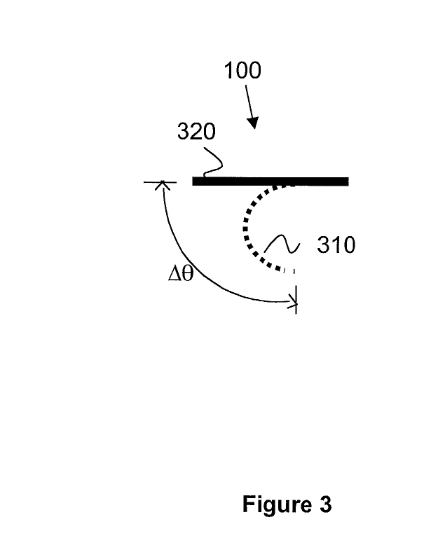

As shown in an exemplary embodiment in FIG. 3, actuator element 110 has a certain strain gradient in a curved shape 310, which is the first phase. The strain gradient decreases during the phase transformation by straightening curved shaped 310 into a linear shape 320, which is the second phase. By taking advantage of this strain gradient variation during the SMA phase transformation from the first phase to the second phase, the actuators of the present invention can achieve large deflection as indicated by Δθ. Therefore, the actuators of the present invention can be scaled down and miniaturized to meso or micro-scale range without losing functionality.

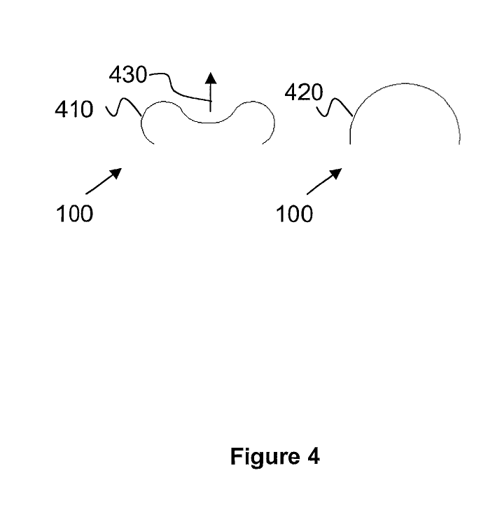

The actuator elements of the present invention can be positioned in any type of shape. For instance, as shown in FIG. 3, actuator element 110 in the first phase can be any type of curved shape. However, the actuator element can also be any type of non-linear shape or any type of irregular shape as long as a strain gradient can be established. FIG. 3 shows a rotary action or movement of actuator element 110. Although, the example in FIG. 3 shows a linear position in the second phase, the second phase does not have to be perfectly linear, it could also be substantially linear or less curved compared to the first phase as long as it is in the direction to minimize the strain gradient. FIG. 4 shows actuator element 110 with a non-linear shape 410 in the first phase before activation by activation means. Once actuator element 110 has been activated and a transition in actuator element 110 has occurred to the second phase, the resulting second phase can also be any type of shape as shown by 420 as long as it is different compared to 410. In this case, shape 420 is a different non-linear shape. Furthermore, FIG. 4 shows a linear action that can generate a push motion 430 by actuator element 110.

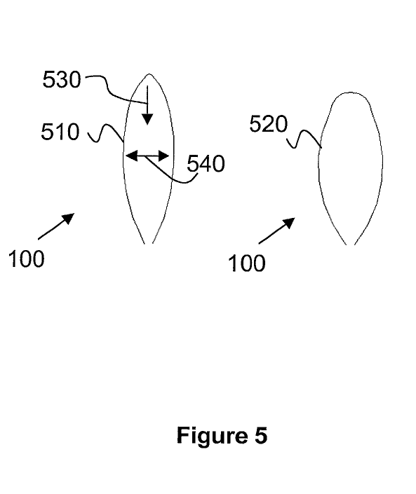

FIG. 5 shows actuator element 110 with a different non-linear shape 510 in the first phase before activation by activation means. Once actuator element 110 has been activated and a transition in the actuator element has occurred to the second phase, the resulting second phase can also be any type of shape as shown by 520 as long as it minimizes the strain gradient. In this case, shape 520 is again a different non-linear shape compared to 510. Furthermore, FIG. 5 shows a linear action that can generate a pull motion 530 by actuator element 110. In addition, FIG. 5 shows an expanding (rotary) action or movement by actuator element 110 as indicated by 540. In this particular example of FIG. 5, a combined linear 530 and rotary or expanding 540 movement or action can be achieved. As one skilled in the art might readily appreciate, the actuator element can be positioned in various different shapes or configurations and can generate different types of linear, rotary, expanding movements or actions. The present invention is not limited to any combination of these different movements or actions such as a combined linear and rotary movement. Furthermore, the linear actions generated from strain gradient variation can be combined with contraction motion and implemented to produce stronger force with larger deflection.

Accordingly, the present invention also includes a method of making or providing an actuator. The first step in making the actuator is to provide an actuator element, which is preferably an SMA. The second step is to provide a strain gradient variation between a first phase and a second phase of the actuator element as discussed above. The actuator element can be positioned in any kind of configuration which is depended on the type of action or movement one wants to achieve. The third step is to provide an activating means to activate the actuator element and transition the actuator element from a first phase to a second phase as discussed above.

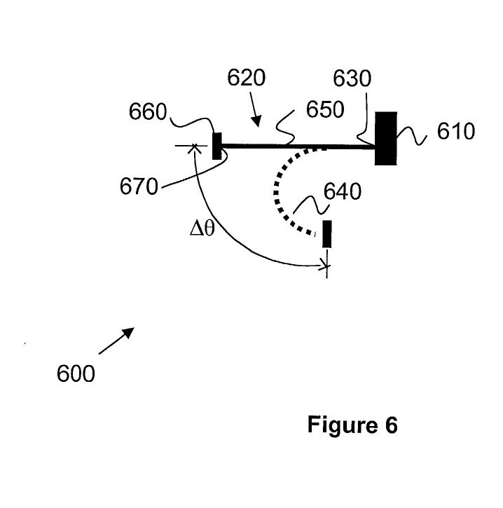

The actuator of the present invention can also be integrated as well as embedded in a device 600 as shown in FIG. 6. As an exemplary embodiment, such an actuator device could include a first body 610. The actuator element 620 as discussed above, could then be attached with a first end 630 to first body 610. Such a device could be used as, for instance, but not limited to, a switch or relay where the other end, in particular the end that is not attached, plays a role in the switching or relay action when the actuator element transitions from the first phase 640 to the second phase 650. The actuator device could further include a second body 660 that is attached to a second end 670 of the actuator element 620.

Alternatively (not shown), the second end could also be attached to the first body so that the actuator element, for instance, is configured in a curved position. A second body could then be attached to a point in between the first end and the second end. This type of configuration is beneficial in a linear movement when one wants to translate the movement from actuator element to the second body.

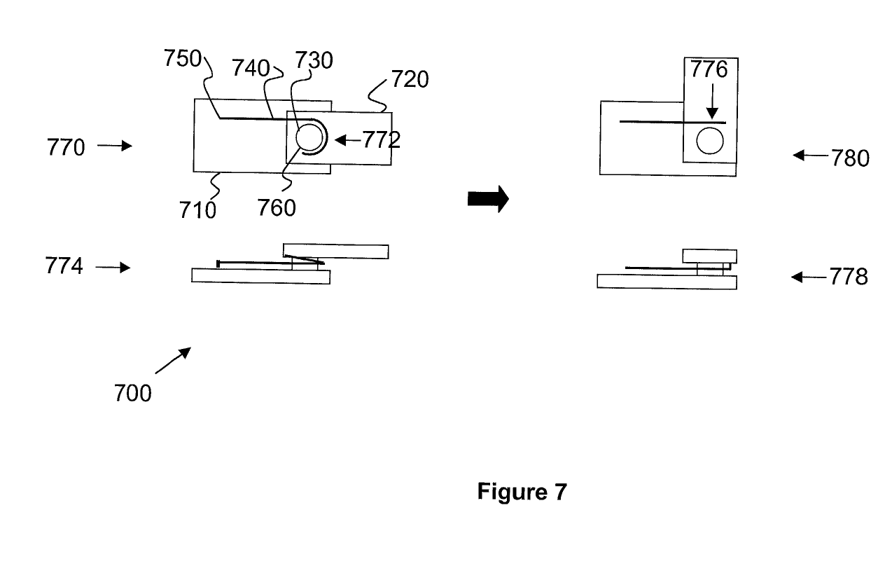

In another example as shown in FIG. 7, the device 700 of the present invention includes a first body 710 which is movably attached to a second body 720 by a connecting means 730. Examples of connecting means are, for instance, but not limited to, a joint, any other structure that movably connects two bodies or the like. Actuator element 740, as discussed above, is attached with a first end 750 to first body 710 and by a second end 760 to second body 720. 770 shows a top view of actuator element 740 in the first position which is a curved shape 772 that imposes a strain gradient to actuator element 740 (774 shows a side view of 770). 780 shows a top view of actuator element 740 in the second position which is a linear shape 776 (778 shows a side view of 770). When actuator element 740 is heated up, a phase transformation occurs such that the actuator element 740 becomes stiff enough to bend itself from curled shape 772 to a memorized shape, which is linear shape 776 in this example, enabling the rotational motion. By following this configuration, the actuators of the present invention could achieve angular deflections of more than 60°. Following the idea of strain gradient variation, SMA wires can easily be embedded into actuator devices.

Accordingly, the present invention also includes a method of making an actuator device. The first step is to provide a first body together with an actuator of the present invention. The actuator is attached with a first end attached to the first body. The second step is to provide a strain gradient between a first phase and a second phase of the actuator element as discussed above. The actuator element can be positioned in any kind of configuration and is depended on the type of action or movement one wants to achieve. The third step is to provide an activating means to activate the actuator element and transition the actuator element from a first phase to a second phase as discussed above. In one embodiment, the method further includes the step of providing a second body that could be attached to a second end of the actuator element. The first body could then be movably attached to the second body by a connecting means, such as a joint. In an alternative embodiment, the method could further include the step of providing a second body wherein the second body is attached to a point in between the first end and the second end of the actuator element. The second end is now attached to the first body. An additional step in the method, which is optional and depended on the application and requirements, is to embed the actuator in the actuator device.

The present invention has now been described in accordance with several exemplary embodiments, which are intended to be illustrative in all aspects, rather than restrictive. Thus, the present invention is capable of many variations in detailed implementation, which may be derived from the description contained herein by a person of ordinary skill in the art. For instance, the present invention can be applied to actuators for large angular motion as well as to other applications, such as, but not limited to, medical devices, robotic devices, joint mechanisms or switches or relays to turn on/off electric circuits. The SMA can be modified to any other shape, such as, an arc-shape, a P-shape, a W-shape and the like, to simplify and/or improve the actuator system. Some specific steps involved in fabricating the actuators and enhancing the actuator bandwidth can be added to the present invention. First, in case of embedding an SMA in a device, one might consider electroplating (fixturing and cooling) of the SMA. One might also consider a self-locking mechanism of the SMA. Second, with regards to materials and process combinations, one might consider, materials with high thermal conductivity but low electrical conductivity (such as Si, Ge and the like). Furthermore, shape deposition manufacturing (SDM) is preferred when embedding, for instance, Si parts into SDM structures to create an Si actuator device. All such variations are considered to be within the scope and spirit of the present invention as defined by the following claims and their legal equivalents.

What is claimed is:

1. An actuator comprising an actuator element with a strain gradient variation between a first phase and a second phase.

2. The actuator as set forth in claim 1, wherein said actuator element comprises a shape memory alloy.

3. The actuator as set forth in claim 2, wherein said shape memory alloy comprises nitinol.

4. The actuator as set forth in claim 2, wherein said first state is a Martensite phase of said shape memory alloy.

5. The actuator as set forth in claim 2, wherein said second phase is an Austenite phase of said shape memory alloy.

6. The actuator as set forth in claim 1, wherein said actuator element in said first phase is positioned in a curved shape with said strain gradient variation along a cross-section of said actuator element.

7. The actuator as set forth in claim 6, wherein said actuator element in said second phase is positioned in a different curved shape when compared to said curved shape in said first phase in a direction to minimize said strain gradient.

8. The actuator as set forth in claim 1, wherein said actuator element in said first phase is positioned in an irregular shape with said strain gradient variation along a cross-section of said actuator element.

9. The actuator as set forth in claim 8, wherein said actuator element in said second phase is positioned in a different irregular shape when compared to said irregular shape in said first phase in a direction to minimize said strain gradient.

10. The actuator as set forth in claim 1, wherein said actuator element in said first phase is positioned in a non-linear shape with said strain gradient variation along a cross-section of said actuator element.

11. The actuator as set forth in claim 10, wherein said actuator element in said second phase is positioned in a different non-linear shape when compared to said non-linear shape in said first phase in a direction to minimize said strain gradient.

12. The actuator as set forth in claim 1, wherein said actuator element in said second phase is positioned in a substantially linear shape.

13. The actuator as set forth in claim 1, further comprising an activating means for said actuator element.

14. The actuator as set forth in claim 13, wherein said activating means comprises a heating means.

15. The actuator as set forth in claim 1, wherein said actuator element generates a rotary movement when transitioning from said first phase to said second phase.

16. The actuator as set forth in claim 1, wherein said actuator element generates a linear movement when transitioning from said first phase to said second phase.

17. The actuator as set forth in claim 1, wherein said actuator element generates an expanding movement when transitioning from said first phase to said second phase.

18. The actuator as set forth in claim 1, wherein said actuator element generates a combined linear and rotary movement when transitioning from said first phase to said second phase.

19. The actuator as set forth in claim 1, wherein said actuator element generates a linear movement by combining a contraction and said strain gradient.

20. A method of providing an actuator, comprising the steps of:
(a) providing an actuator element;
(b) providing a strain gradient variation between a first phase and a second phase of said actuator element; and
(c) providing an activating means to activate said actuator element and transition said actuator element from said first phase to said second phase.

21. The method as set forth in claim 20, wherein said actuator element comprises a shape memory alloy.

22. The method as set forth in claim 21, wherein said shape memory alloy comprises nitinol.

23. The method as set forth in claim 21, wherein said first state is a Martensite phase of said shape memory alloy.

24. The method as set forth in claim 21, wherein said second phase is an Austenite phase of said shape memory alloy.

25. The method as set forth in claim 20, wherein said actuator element in said first phase is positioned in a curved shape with said strain gradient variation along a cross-section of said actuator element.

26. The method as set forth in claim 25, wherein said actuator element in said second phase is positioned in a different curved shape when compared to said curved shape in said first phase in a direction to minimize said strain gradient.

27. The method as set forth in claim 20, wherein said actuator element in said first phase is positioned in an irregular shape with said strain gradient variation along a cross-section of said actuator element.

28. The method as set forth in claim 27, wherein said actuator element in said second phase is positioned in a different irregular shape when compared to said irregular shape in said first phase in a direction to minimize said strain gradient.

29. The method as set forth in claim 20, wherein said actuator element in said first phase is positioned in a non-linear shape with said strain gradient variation along a cross-section of said actuator element.

30. The method as set forth in claim 29, wherein said actuator element in said second phase is positioned in a different non-linear shape when compared to said non-linear shape in said first phase in a direction to minimize said strain gradient.

31. The method as set forth in claim 20, wherein said actuator element in said second phase is positioned in a substantially linear shape.

32. The method as set forth in claim 20, further comprising an activating means for said actuator element.

33. The method as set forth in claim 32, wherein said activating means comprises a heating means.

34. The method as set forth in claim 20, wherein said actuator element generates a rotary movement when transitioning from said first phase to said second phase.

35. The method as set forth in claim 20, wherein said actuator element generates a linear movement when transitioning from said first phase to said second phase.

36. The method as set forth in claim 20, wherein said actuator element generates an expanding movement when transitioning from said first phase to said second phase.

37. The method as set forth in claim 20, wherein said actuator element generates a combined linear and rotary movement when transitioning from said first phase to said second phase.

38. The method as set forth in claim 20, wherein said actuator element generates a linear movement by combining a contraction and said strain gradient.

39. An actuator device, comprising:
(a) a first body; and
(b) an actuator element with a first end attached to said first body, wherein said actuator element has a strain gradient variation between a first phase and a second phase.

40. The device as set forth in claim 39, further comprising a second body attached to a second end of said actuator element.

41. The device as set forth in claim 40, wherein said first body is movably attached to said second body by a connecting means.

42. The device as set forth in claim 39, further comprising a second body wherein said second body is attached to a point in between said first end and a second end of said actuator element and said second end is attached to said first body.

43. The device as set forth in claim 39, wherein said actuator element is embedded in said actuator device.

44. A method of providing an actuator device, comprising the steps of:
(a) providing a first body;
(b) providing an actuator element with a first end attached to said first body;
(c) providing a strain gradient variation between a first phase and a second phase of said actuator element; and
(d) providing an activating means to activate said actuator element and transition said actuator element from said first phase to said second phase.

45. The method as set forth in claim 44, further comprising the step of providing a second body attached to a second end of said actuator element.

46. The method as set forth in claim 45, wherein said first body is movably attached to said second body by a connecting means.

47. The method as set forth in claim 44, further comprising the step of providing a second body wherein said second body is attached between said first end and a second end of said actuator element and said second end is attached to said first body.

48. The method as set forth in claim 44, wherein said actuator element is embedded in said actuator device.
